(19) United States
(12) Patent Application Publication
(10) Pub. No.: US 2021/0203846 A1
(43) Pub. Date: Jul. 1, 2021

(54) METHOD FOR CONFIGURING FISHEYE LENS CAMERA AND ELECTRONIC DEVICE USING THE SAME

(71) Applicant: Acer Incorporated, New Taipei City (TW)

(72) Inventor: Sergio Cantero Clares, New Taipei City (TW)

(73) Assignee: Acer Incorporated, New Taipei City (TW)

(21) Appl. No.: 17/005,311

(22) Filed: Aug. 27, 2020

(30) Foreign Application Priority Data
Dec. 31, 2019 (TW) 108148601

(51) Int. Cl. H04N 5/232; H04N 5/225; H04N 5/262; G02B 13/06; G03B 37/00

(52) U.S. Cl. CPC H04N 5/23245; H04N 5/2254; H04N 5/2628; G03B 37/00; H04N 5/23229; G02B 13/06; H04N 5/2257

(57) ABSTRACT

A method for configuring a fisheye lens camera and an electronic device using the same are provided. The method for configuring the fisheye lens camera includes: disposing the fisheye lens camera on a shell of an electronic device; determining that the fisheye lens camera corresponds to at least one mode; and cropping an output image from a field of view of the fisheye lens camera according to the at least one mode.

### CROSS-REFERENCE TO RELATED APPLICATION

This application claims the priority benefit of Taiwan application serial no. 108148601, filed on Dec. 31, 2019. The entirety of the above-mentioned patent application is hereby incorporated by reference herein and made a part of this specification.

### BACKGROUND OF THE INVENTION

### 1. Field of the Invention

The invention relates to a method and an electronic device, and in particular, to a method for configuring a fisheye lens camera and an electronic device using the same.

### 2. Description of Related Art

In the prior art, a width of an upper cover (B cover) (that is, a screen side) of a notebook computer is designed to be thinner and lighter. Therefore, parameters such as a size, a focal length, and an aperture of a lens disposed on the upper cover are limited by a size of the upper cover, and quality of an image captured by the lens is reduced. In this case, some manufacturers move a position of the lens to a lower cover (C cover) (that is, a keyboard side) of the notebook computer. In this way, a specification of the lens is not easily affected by the width of the upper cover.

However, placing the lens on the lower cover causes a perspective of the image captured by the lens to change. For example, the lens may capture a human face in a bottom-up manner so that an output image unduly highlights a chin or a nose. This type of output image is generally negatively evaluated. In addition, a lens with a fixed field of view (FoV) cannot capture an object or a user at an optimal angle in different scenarios.

### SUMMARY OF THE INVENTION

The invention provides a method for configuring a fisheye lens camera and an electronic device using the same, so that a capturing mode of the fisheye lens camera can be switched to make an output image more beautiful.

An electronic device in the invention includes a shell, a fisheye lens camera, and a processor. The fisheye lens camera is disposed on the shell. The processor is coupled to the fisheye lens camera, where the processor determines that the fisheye lens camera corresponds to at least one mode and crops an output image from an FoV of the fisheye lens camera according to the at least one mode.

In an embodiment of the invention, the at least one mode corresponds to one of the following: a user facing mode and a world facing mode.

In an embodiment of the invention, in response to the fact that the at least one mode corresponds to the world facing mode, the processor locates a center of a cropping range of the output image on a central axis of the fisheye lens camera.

In an embodiment of the invention, in response to the fact that the at least one mode corresponds to the user facing mode, the processor locates a cropping range of the output image between a center axis of the fisheye lens camera and a boundary of the FoV.

In an embodiment of the invention, the at least one mode corresponds to one of the following: a straight mode and a sideways mode.

In an embodiment of the invention, the fisheye lens camera is disposed in a groove of the shell.

In an embodiment of the invention, the fisheye lens camera is obliquely disposed in a groove of the shell, and an included angle between a central axis of the fisheye lens camera and a surface of the shell is between 0 degrees and 90 degrees.

In an embodiment of the invention, the shell includes an adjustable rotating member, where the fisheye lens camera is disposed on the adjustable rotating member, and an included angle between a central axis of the fisheye lens camera and a surface of the shell is between 0 degrees and 90 degrees.

In an embodiment of the invention, the electronic device is one of a notebook computer and a 2-in-1 laptop, and the shell corresponds to a keyboard side.

A method for configuring a fisheye lens camera in the invention includes: disposing the fisheye lens camera on a shell of an electronic device; determining that the fisheye lens camera corresponds to at least one mode; and cropping an output image from an FoV of the fisheye lens camera according to the at least one mode.

Based on the above, in the invention, a capturing mode of the fisheye lens camera can be switched based on different scenarios, so that a to-be-captured target can be captured at an optimal angle.

### BRIEF DESCRIPTION OF THE DRAWINGS

FIG. 1A and FIG. 1B are schematic diagrams illustrating capturing of an object in different scenarios using a conventional lens camera.

FIG. 2A is a schematic diagram illustrating an electronic device according to an embodiment of the invention.

FIG. 2B is a schematic diagram illustrating one pattern of an electronic device according to an embodiment of the invention.

FIG. 3A is a schematic diagram illustrating a fisheye lens camera horizontally disposed in a groove according to an embodiment of the invention.

FIG. 3B is a schematic diagram illustrating a fisheye lens camera obliquely disposed in a groove according to an embodiment of the invention.

FIG. 4 is a flowchart illustrating a method for configuring a fisheye lens camera according to an embodiment of the invention.

FIG. 5 is a detailed flowchart illustrating a step of a method for configuring a fisheye lens camera according to an embodiment of the invention.

FIG. 6A and FIG. 6B are schematic diagrams illustrating capturing of an object in different scenarios using a fisheye lens camera according to an embodiment of the invention.

FIG. 7A is a schematic diagram illustrating an FOV map and a captured image corresponding to a world facing mode according to an embodiment of the invention.

FIG. 7B is a schematic diagram illustrating an FOV map and a captured image corresponding to a user facing mode according to an embodiment of the invention.

FIG. 7C is a schematic diagram illustrating an FOV map and a captured image corresponding to a user facing mode according to another embodiment of the invention.

FIG. 7D is a schematic diagram illustrating an FOV map and a captured image corresponding to an oblique fisheye lens camera and a use facing mode according to an embodiment of the invention.

FIG. 7E is a schematic diagram illustrating an FOV map and a captured image corresponding to an oblique fisheye lens camera and a world facing mode according to an embodiment of the invention.

FIG. 8 is a schematic diagram illustrating a captured image corresponding to a sideways mode and a captured image corresponding to a straight mode according to an embodiment of the invention.

FIG. 9 is a flowchart illustrating a method for configuring a fisheye lens camera according to another embodiment of the invention.

### DESCRIPTION OF THE EMBODIMENTS

In order to make the content of the invention easier to understand, the following specific embodiments are given as examples by which the invention can be implemented. In addition, wherever possible, the same reference numbers of components/components/steps are used in the drawings and embodiments to represent the same or similar components.

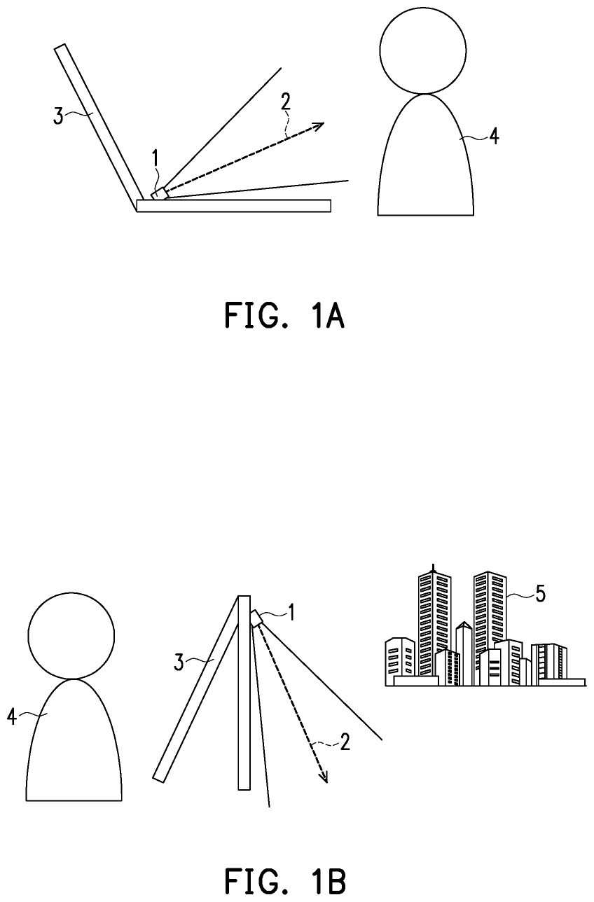

Because an FOV of a conventional lens camera is relatively narrow, a user usually needs to configure the camera with a fixed FOV according to a use scenario. FIG. 1A and FIG. 1B are schematic diagrams illustrating capturing of an object in different scenarios using a conventional lens camera 1. Referring to FIG. 1A, the conventional lens camera 1 is disposed on a lower cover of a notebook computer 3, the conventional lens camera 1 being configured by default to shoot a user. In other words, a user facing mode is configured for the conventional lens camera 1, the user facing mode being also referred to as a “selfie mode” or a “front facing mode”. Based on the above, when the notebook computer 3 is placed on a desktop, a direction 2 of an FOV of the conventional lens camera 1 may exactly face a user 4 sitting next to the notebook computer 3, so that the conventional lens camera 1 can capture a complete image of the user 4. However, when the user 4 holds up the notebook computer 3 to shoot other target objects 5 (for example, people or buildings around the user 4), because the direction 2 of the FOV of the conventional lens camera 1 is fixed, it is difficulty for the user 4 to make the direction 2 of the FOV of the conventional lens camera 1 face the target object 5 by operating the notebook computer 3, as shown in FIG. 1B.

In order to enable the camera to perform shooting at an optimal angle in different scenarios, the invention provides a technology based on a fisheye lens camera. In this technology, a wide FOV of the fisheye lens camera can be used to perform shooting in different scenarios.

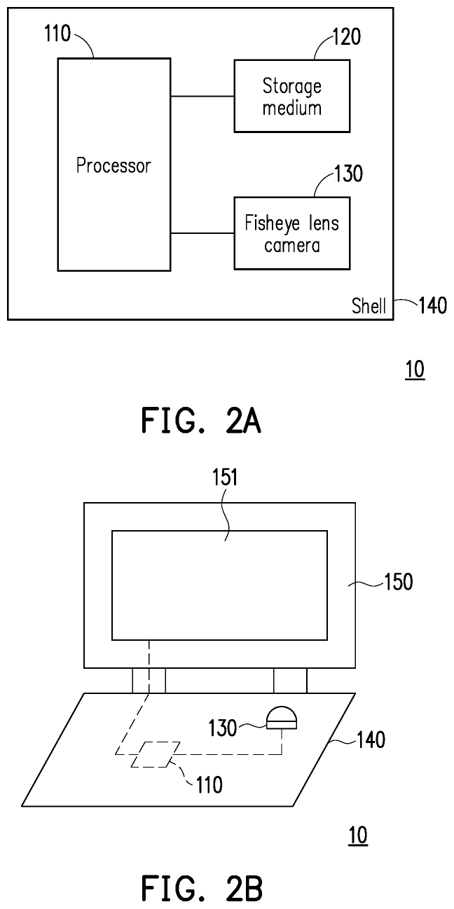

FIG. 2A is a schematic diagram illustrating an electronic device 10 according to an embodiment of the invention. The electronic device 10 may include a processor 110, a storage medium 120, a fisheye lens camera 130, and a shell 140. The electronic device 10 is, for example, a notebook computer, a tablet computer, or a 2-in- 1 computer, but the invention is not limited thereto.

The processor 110 is, for example, a graphics processing unit (GPU), an image signal processor (ISP), an image processing unit (IPU), a central processing unit (CPU), another programmable general purpose or special purpose micro control unit (MCU), a microprocessor, a digital signal processor (DSP), a programmable controller, a special application specific integrated circuit (ASIC), an arithmetic logic unit (ALU), a complex programmable logic device (CPLD), a field programmable gate array (FPGA) or other similar components or a combination of the foregoing components. The processor 110 may be coupled to the storage medium 120 and the fisheye lens camera 130, and may access and execute a plurality of modules and various application programs stored in the storage medium 120.

The storage medium 120 is, for example, any type of fixed or removable random access memory (RAM), a read-only memory (ROM), a flash memory, a hard disk drive (HDD), a solid state drive (SSD), or similar components or a combination of the foregoing components, and is configured to store the plurality of modules or the various application programs that can be executed by the processor 110.

Compared with the conventional lens camera 1, the fisheye lens camera 130 has a wider FOV. For example, an FOV of the fisheye lens camera 130 may be between 135 degrees and 180 degrees.

In an embodiment, the processor 110 and the storage medium 120 may be disposed on the shell 140, and the fisheye lens camera 130 may be disposed on a surface of the shell 140. The shell 140 is, for example, a lower cover (that is, a keyboard side) of a notebook computer or a 2-in-1 computer, or a shell of a tablet computer.

FIG. 2B is a schematic diagram illustrating one pattern of an electronic device 10 according to an embodiment of the invention. In the present embodiment, the electronic device 10 is a notebook computer (or a two-in-one computer). The electronic device 10 may include a lower cover 140 and an upper cover 150. A display 151 may be disposed on the upper cover 150. The processor 110 (and/or the storage medium 120) may be disposed in a shell of the lower cover 140, and the fisheye lens camera 130 (or a component such as a keyboard or a touch pad) may be disposed on a surface of the lower cover 140.

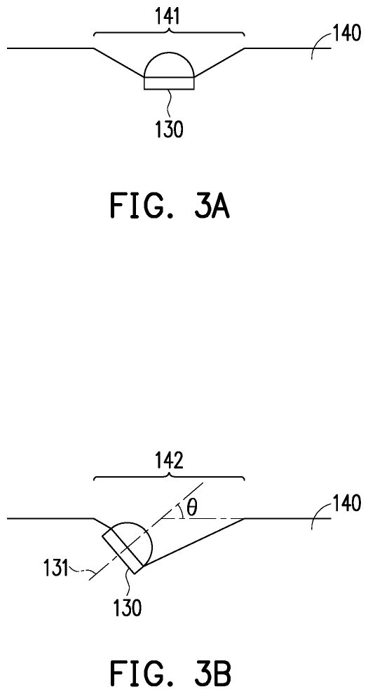

The fisheye lens camera 130 may be disposed in a plurality of patterns. FIG. 3A is a schematic diagram illustrating a fisheye lens camera 130 horizontally disposed in a groove 141 according to an embodiment of the invention. The groove 141 is located on the surface of the shell 140. The groove 141 can prevent the fisheye lens camera 130 from being damaged. Taking FIG. 2B as an example, disposing the fisheye lens camera 130 in the groove 141 of the shell 140 can prevent the fisheye lens camera 130 from being crushed when the upper cover 150 of the electronic device 10 (that is, the notebook computer) is lifted.

FIG. 3B is a schematic diagram illustrating a fisheye lens camera 130 obliquely disposed in a groove 142 according to an embodiment of the invention. As shown in FIG. 3B, the fisheye lens camera 130 may be obliquely disposed in the groove 142 on the surface of the shell 140, so that a central axis 131 of the fisheye lens camera 130 and the surface of the shell 140 form an included angle θ. In the present embodiment, the included angle θ may be 45 degrees, but the invention is not limited thereto. For example, the included angle θ may be between 0 degrees and 90 degrees. In an embodiment, an adjustable rotating member may be disposed in the groove (for example, the groove 142) of the shell 140. The fisheye lens camera 130 may be disposed on the adjustable rotating member. A user may operate the adjustable rotating member as required, thereby changing the included angle θ between the central axis 131 of the lens camera 120 and the shell 140, the included angle θ being adjusted to be between 0 degrees and 90 degrees.

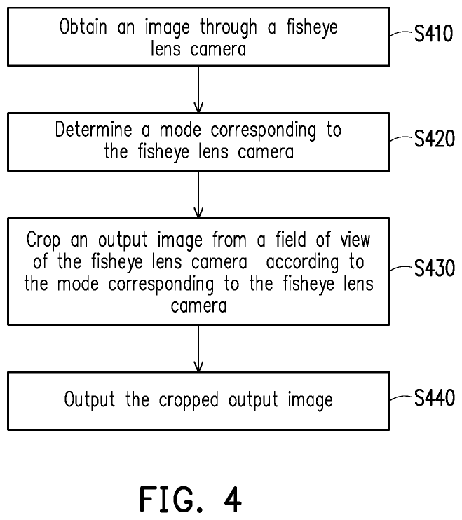

In the present embodiment, the processor 110 may automatically adjust the direction of the FOV of the fisheye lens camera 130 so that the fisheye lens camera 130 can be adapted to different scenarios. FIG. 4 is a flowchart illustrating a method for configuring a fisheye lens camera 130 according to an embodiment of the invention. The method may be implemented by the electronic device 10 shown in FIG. 2A.

In step S410, the processor 110 may obtain an image through the fisheye lens camera 130. In step S420, the processor 110 may determine a mode corresponding to the fisheye lens camera 130 (or a mode corresponding to an operating system (OS) of the electronic device 10). The mode corresponding to the fisheye lens camera 130 may include, for example, a user facing mode or a world facing mode, but the invention is not limited thereto. In an embodiment, the mode corresponding to the fisheye lens camera 130 (or the OS of the electronic device 10) may include, for example, a notebook computer mode or a tablet computer mode, but the present invention is not limited thereto. The notebook computer mode may correspond to, for example, the user facing mode, and the tablet computer mode may correspond to, for example, the world facing mode.

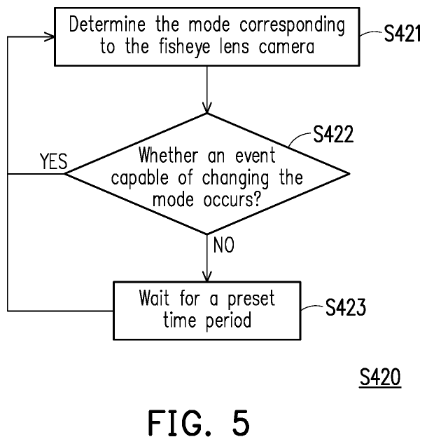

In an embodiment, the processor 110 may periodically determine the mode corresponding to the fisheye lens camera 130. FIG. 5 is a detailed flowchart illustrating a step S420 of a method for configuring a fisheye lens camera 130 according to an embodiment of the invention. In step S421, the processor 110 may determine the mode corresponding to the fisheye lens camera 130. For example, the processor 110 may determine that the current fisheye lens camera 130 corresponds to one of the user facing mode and the world facing mode.

In step S422, the processor 110 may determine whether an event capable of changing the mode occurs. For example, the processor 110 may determine whether the user of the electronic device 10 sends an instruction to the processor 110 through an input device (for example, a touchscreen, a touch panel, a keyboard, or a mouse) coupled to the processor 110, to switch the mode corresponding to the fisheye lens camera 130. For another example, if the electronic device 10 is the notebook computer shown in FIG. 2B, the processor 110 may determine whether the user of the electronic device 10 switches the mode corresponding to the fisheye lens camera 130 by folding the upper cover 150 of the electronic device 10. In particular, the processor 110 may switch the mode corresponding to the fisheye lens camera 130 to the notebook computer mode or the tablet computer mode based on a folded state of the upper cover 150.

If the processor 110 determines that an event capable of changing the mode occurs, step S421 is performed, and the processor 110 determines again the mode corresponding to the fisheye lens camera 130. If the processor 110 determines that no event capable of changing the mode occurs, step S423 is performed. In step S423, the processor 110 waits for a preset time period.

Returning to FIG. 4, in step S430, the processor 110 may crop an output image from the FOV of the fisheye lens camera 130 according to the mode corresponding to the fisheye lens camera 130. The processor 110 may determine a cropping range of the output image according to, for example, an image mapping algorithm or a cropping algorithm. In an embodiment, the processor 110 may pre-process the image captured by the fisheye lens camera 130 in advance to speed up a running time of step S430.

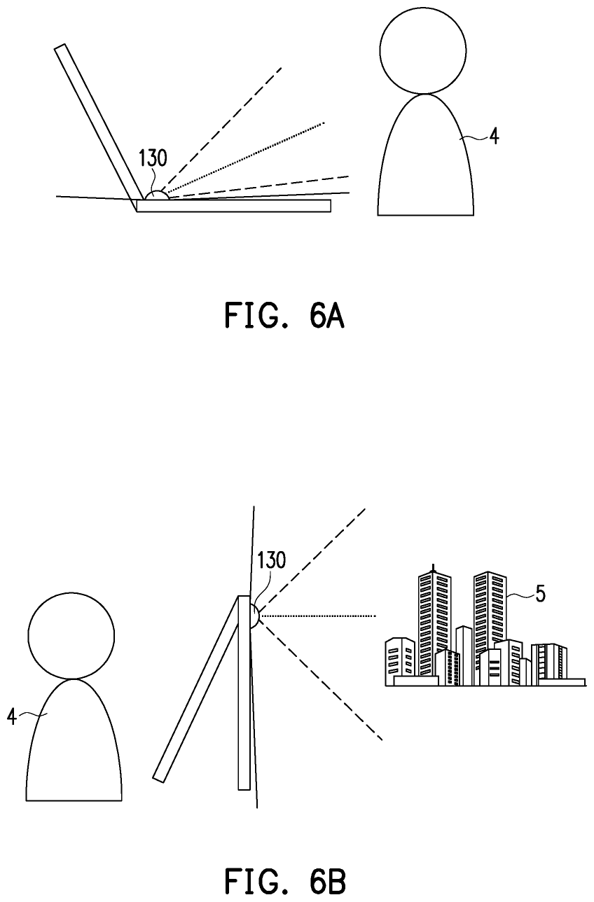

FIG. 6A and FIG. 6B are schematic diagrams illustrating capturing of an object in different scenarios using a fisheye lens camera 130 according to an embodiment of the invention. In the present embodiment, when the fisheye lens camera 130 corresponds to the user facing mode (as shown in FIG. 6A), the processor 110 may crop the image captured by the fisheye lens camera 130 so that the output image can be correctly captured to an image of the user 4. In addition, when the fisheye lens camera 130 corresponds to the world facing mode (as shown in FIG. 6B), the processor 110 may crop the image captured by the fisheye lens camera 130 so that the output image can be correctly captured to an image of the target object 5.

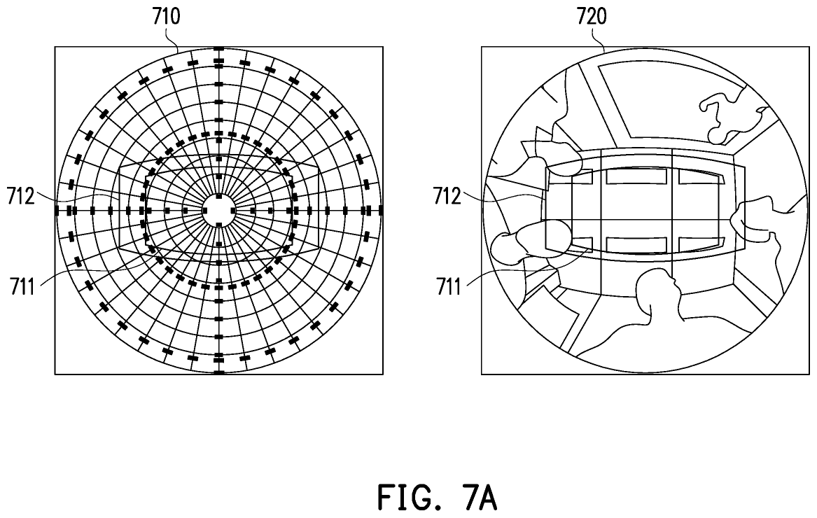

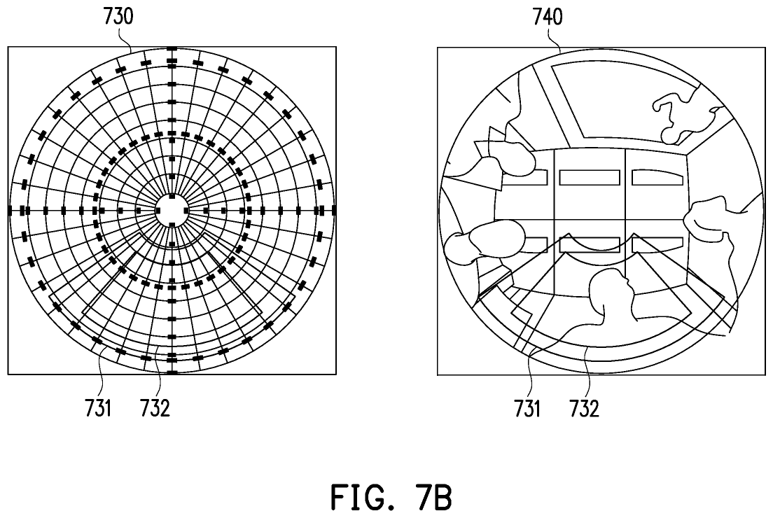

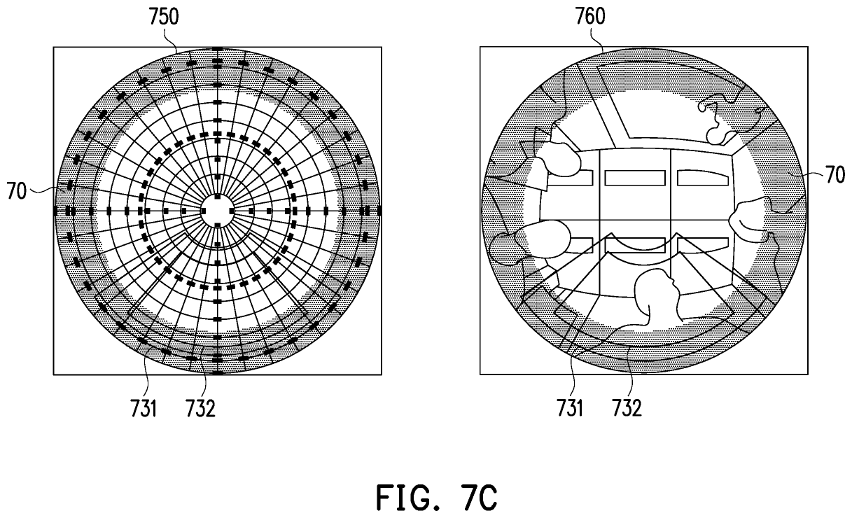

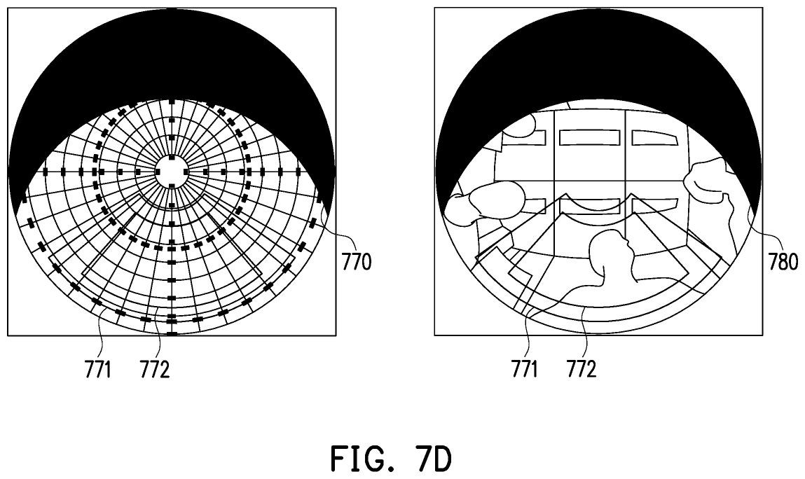

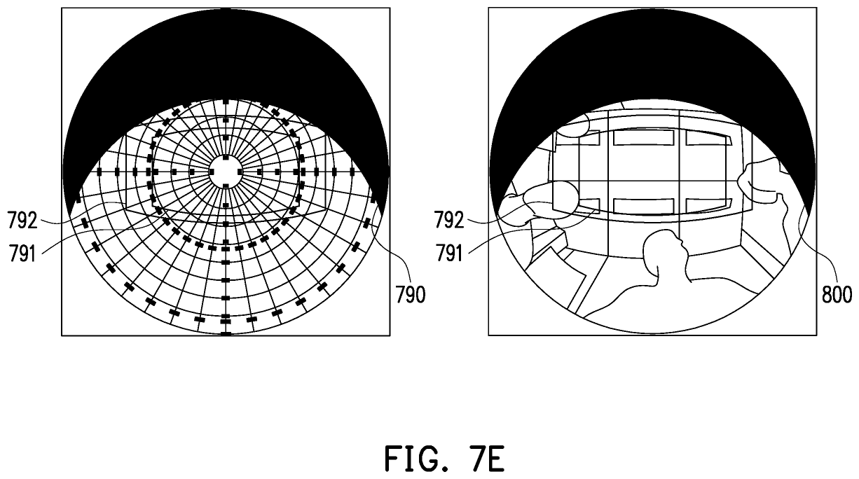

In particular, in response to the fact that the fisheye lens camera 130 corresponds to the world facing mode, the processor 110 may locate a center of the cropping range of the output image of the fisheye lens camera 130 on the central axis of the fisheye lens camera 130, as shown in FIG. 7A. FIG. 7A is a schematic diagram illustrating an FOV 710 map and a captured image 720 corresponding to a world facing mode according to an embodiment of the invention. FIG. 7A corresponds to the fisheye lens camera 130 having a 180-degree FOV, and centers of a plurality of concentric circles in the FOV map 710 (and FOV maps 730, 750, 770, and 790) correspond to the central axis of the fisheye lens camera 130. The processor 110 may adjust the cropping range of the output image based on a use requirement. For example, a cropping range 711 of the output image corresponds to a 45-degree FOV, and a cropping range 712 of the output image corresponds to a 60-degree FOV. When the fisheye lens camera 130 corresponds to the world facing mode, the processor 110 may locate a center of the cropping range 711 of the output image or the cropping range 712 of the output image on the central axis of the fisheye lens camera 130, as shown in the FOV map 710.

In addition, in response to the fact that the fisheye lens camera 130 corresponds to the user facing mode, the processor 110 may locate the cropping range of the output image of the fisheye lens camera 130 between the central axis of the fisheye lens camera 130 and a boundary of the FoV of the fisheye lens camera 130, as shown in FIG. 7B. FIG. 7B is a schematic diagram illustrating an FOV 730 and a captured image 740 corresponding to a user facing mode according to an embodiment of the invention. FIG. 7B corresponds to the fisheye lens camera 130 having a 180-degree FOV, a cropping range 731 of the output image corresponds to a 45-degree FOV, and a cropping range 732 of the output image corresponds to a 60-degree FOV. Referring to the FOV map 730, in the present embodiment, a circle (that is, a circle representing 90 degrees) at an outermost side of the FOV map 730 is defined as the boundary of the FOV of the fisheye lens camera 130. In other words, the boundary of the FOV of the fisheye lens camera 130 having the 180-degree FOV is 90 degrees.

In order to reduce a pixel count or increase a pixel density of the output image, the fisheye lens camera 130 with a relatively narrow FOV may be used. However, if the FOV of the fisheye lens camera 130 is too narrow (for example, the FOV is less than 180 degrees), a part of the image that needs to be output is not cropped into the output image, as shown in FIG. 7C. FIG. 7C is a schematic diagram illustrating an FOV map 750 and a captured image 760 corresponding to a user facing mode according to another embodiment of the invention. FIG. 7C corresponds to the fisheye lens camera 130 having a 135-degree FOV. In the present embodiment, an ideal output image needs to be corresponding to a cropping range 751 of an output image in a 45-degree FOV or a cropping range 752 of an output image in a 60-degree FOV. However, because the FOV of the fisheye lens camera 130 is too narrow, the FOV 750 map and a portion 70 of the captured image 760 (that is, a portion corresponding to a 67.5-degree FOV to a 90-degree FOV of the fisheye lens camera 130) cannot be captured by the fisheye lens camera 130. As a result, a to-be-captured person cannot be completely captured in the output image.

In this case, in an embodiment, the fisheye lens camera 130 may be obliquely disposed on the shell 140 (as shown in FIG. 3B) of the electronic device 10, to change an area of the image captured by the fisheye lens camera 130 by adjusting a direction of the central axis 131 of the fisheye lens camera 130. It should be noted that the FOV of the fisheye lens camera 130 needs to be greater than or equal to 180°−θ.

FIG. 7D is a schematic diagram illustrating an FOV map 770 and a captured image 780 corresponding to an oblique fisheye lens camera 130 and a use facing mode according to an embodiment of the invention. FIG. 7D corresponds to the fisheye lens camera 130 having a 135-degree FOV, a cropping range 771 of the output image corresponds to a 45-degree FOV, and a cropping range 772 of the output image corresponds to a 60-degree FOV. In addition, FIG. 7E is a schematic diagram illustrating an FOV map 790 and a captured image 800 corresponding to an oblique fisheye lens camera 130 and a world facing mode according to an embodiment of the invention. FIG. 7E corresponds to the fisheye lens camera 130 having a 135-degree FOV, a cropping range 791 of the output image corresponds to a 45-degree FOV, and a cropping range 792 of the output image corresponds to a 60-degree FOV. As shown in FIG. 7D, the central axis 131 of the oblique fisheye lens camera 130 deviates from an original position, so that the to-be-captured person can be completely captured in the cropping range 771 of the output image or the cropping range 772 of the output image.

Returning to FIG. 4, in step S440, the processor 110 may output the cropped output image.

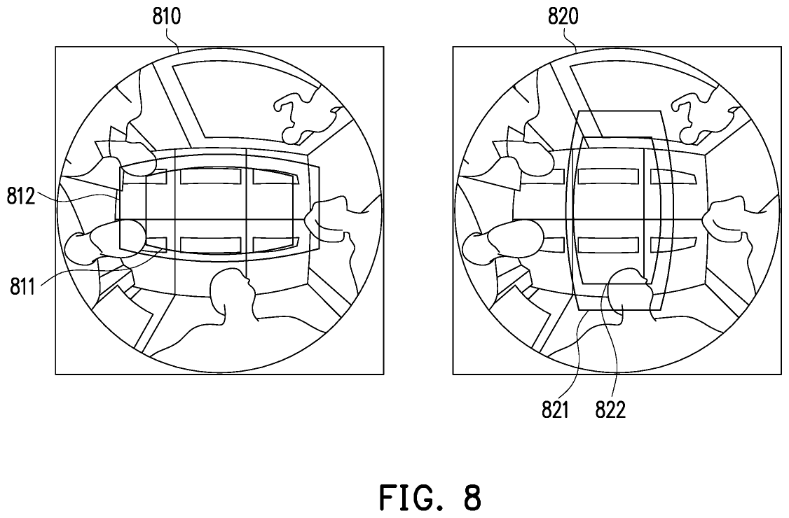

In addition to the fact that the fisheye lens camera 130 corresponds to the user facing mode or the world facing mode, in an embodiment, the mode corresponding to the fisheye lens camera 130 (or the mode corresponding to the OS of the electronic device 10) may further include, for example, a straight mode or a sideways mode. In particular, the processor 110 may crop a horizontal output image from the FOV of the fisheye lens camera 130 in response to the fact that the fisheye lens camera 130 corresponds to the sideways mode, and crop a vertical output image from the FOV of the fisheye lens camera 130 in response to the fact that the fisheye lens camera 130 corresponds to the straight mode. FIG. 8 is a schematic diagram illustrating a captured image 810 corresponding to a sideways mode and a captured image 820 corresponding to a straight mode according to an embodiment of the invention. FIG. 8 corresponds to the fisheye lens camera 130 having a 180-degree FOV, a cropping range 811 of a horizontal output image corresponds to a 45-degree FOV, a cropping range 812 of a horizontal output image corresponds to a 60-degree FOV, a vertical output image 821 corresponds to a 45-degree FOV, and a vertical output image 822 corresponds to a 60-degree FOV.

In an embodiment, the fisheye lens camera 130 may correspond to one of the user facing mode and the world facing mode, and may correspond to one of the straight mode and the sideways mode.

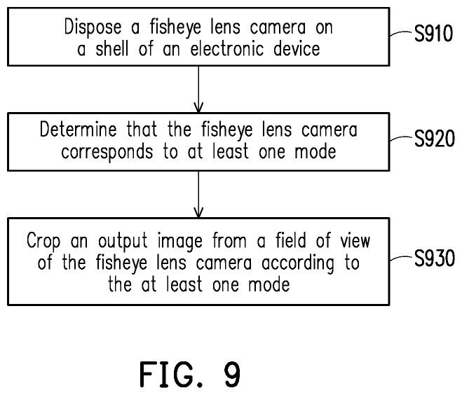

FIG. 9 is a flowchart illustrating a method for configuring a fisheye lens camera 130 according to another embodiment of the invention. The method may be implemented by the electronic device 10 shown in FIG. 2A. In step S910, the fisheye lens camera 130 is disposed on a shell 140 of the electronic device 10. In step S920, it is determined that the fisheye lens camera 130 corresponds to at least one mode. In step S930, an output image is cropped from an FOV of the fisheye lens camera 130 according to the at least one mode.

In view of the above, in the invention, a direction of the FOV of the fisheye lens camera may be adjusted according to a mode corresponding to the fisheye lens camera. When the fisheye lens camera corresponds to a world facing mode, a center of the cropped output image is located on a center axis of the fisheye lens camera. In addition, when the fisheye lens camera corresponds to a user facing mode, the output image is located off the central axis. In other words, in the invention, a capturing mode of the fisheye lens camera can be switched based on different scenarios, so that a to-be-captured target can be captured at an optimal angle.

What is claimed is:

1. An electronic device, comprising:
a shell;
a fisheye lens camera disposed on the shell; and
a processor coupled to the fisheye lens camera, wherein the processor determines that the fisheye lens camera corresponds to at least one mode and crops an output image from a field of view of the fisheye lens camera according to the at least one mode.

2. The electronic device according to claim 1, wherein the at least one mode corresponds to one of the following: a user facing mode and a world facing mode.

3. The electronic device according to claim 2, wherein in response to the at least one mode corresponding to the world facing mode, the processor locates a center of a cropping range of the output image on a central axis of the fisheye lens camera.

4. The electronic device according to claim 2, wherein in response to the at least one mode corresponding to the user facing mode, the processor locates a cropping range of the output image between a center axis of the fisheye lens camera and a boundary of the field of view.

5. The electronic device according to claim 1, wherein the at least one mode corresponds to one of the following: a straight mode and a sideways mode.

6. The electronic device according to claim 1, wherein the fisheye lens camera is disposed in a groove of the shell.

7. The electronic device according to claim 1, wherein the fisheye lens camera is obliquely disposed in a groove of the shell, and an included angle between a central axis of the fisheye lens camera and a surface of the shell is between 0 degrees and 90 degrees.

8. The electronic device according to claim 1, wherein the shell comprises:
an adjustable rotating member, wherein the fisheye lens camera is disposed on the adjustable rotating member, and an included angle between a central axis of the fisheye lens camera and a surface of the shell is between 0 degrees and 90 degrees.

9. The electronic device according to claim 1, wherein the electronic device is one of a notebook computer and a 2-in-1 laptop, and the shell corresponds to a keyboard side.

10. A method for configuring a fisheye lens camera, comprising:
disposing the fisheye lens camera on a shell of an electronic device;
determining that the fisheye lens camera corresponds to at least one mode; and
cropping an output image from a field of view of the fisheye lens camera according to the at least one mode.

11. The method according to claim 10, wherein the at least one mode corresponds to one of the following: a user facing mode and a world facing mode.

12. The method according to claim 11, further comprising:
in response to the at least one mode corresponding to the world facing mode, locating a center of a cropping range of the output image on a central axis of the fisheye lens camera.

13. The method according to claim 11, further comprising:
in response to the at least one mode corresponding to the user facing mode, locating a cropping range of the output image between a center axis of the fisheye lens camera and a boundary of the field of view.

14. The method according to claim 10, wherein the fisheye lens camera is obliquely disposed in a groove of the shell, and an included angle between a central axis of the fisheye lens camera and a surface of the shell is between 0 degrees and 90 degrees.

15. The method according to claim 10, further comprising:
disposing the fisheye lens camera on an adjustable rotating member, wherein an included angle between a central axis of the fisheye lens camera and a surface of the shell is between 0 degrees and 90 degrees.
